(19) United States
(12) Patent Application Publication
(10) Pub. No.: US 2020/0109563 A1
(43) Pub. Date: Apr. 9, 2020

(54) SPLIT NUT FOR MONOPOLE BASE

(71) Applicant: Sabre Communications Corporation, Sioux City, IA (US)

(72) Inventors: Leo Dan Padron, Fort Worth, TX (US); Hock Hai Lim, Arlington, TX (US)

(21) Appl. No.: 16/201,641

(22) Filed: Nov. 27, 2018

Related U.S. Application Data
(63) Continuation-in-part of application No. 16/154,865, filed on Oct. 9, 2018.

(51) Int. Cl. E04C 5/16; F16B 37/04; F16B 37/08; F16B 7/18

(52) U.S. Cl. CPC E04C 5/163; F16B 37/041; F16L 19/0231; F16B 7/18; F16B 37/0892

(57) ABSTRACT

A split nut can include a first nut portion and a second nut portion. The first nut portion can define a first receptacle and a second receptacle. The second nut portion can define a first passage and a second passage, and the first and second passages can be respectively located to align with the first and second receptacles. A first pin and a second pin can respectively extend through the first and second passages to respectively engage with the first and second receptacles, for instance to secure the first and second nut portions together to close the split nut and thereby define a nut passage.

### CLAIM OF PRIORITY

This patent application is a continuation-in-part of, and claims the benefit of priority of, Padron et al. U.S. patent application Ser. No. 16/154,865, entitled “CUSTOM NUT SYSTEM AND METHOD OF ADAPTING NON-CONFORMING TOWER BASE,” filed on Oct. 9, 2018 (Attorney Docket No. 1496.014US1), which is hereby incorporated by reference herein in its entirety.

### TECHNICAL FIELD

This document pertains generally, but not by way of limitation, to fasteners.

### BACKGROUND

Utility poles support equipment (e.g., power wires, telecommunications equipment or wires, or the like) above ground level. Utility poles can be mounted to a foundation.

### SUMMARY

The present inventors have recognized, among other things, that a problem to be solved can include coupling a unitary nut (e.g., a nut that is a single or continuous piece) to a utility pole mounting structure, such as where a threaded portion of the utility pole mounting structure is inaccessible to the unitary nut. For instance, one or more anchor posts can be included in the mounting structure, and the anchor posts can extend from an anchoring surface (e.g., ground surface, a concrete footing, or the like). A collar can be coupled with the one or more anchor posts (such as can include using unitary nuts supporting the collar from underneath) and the collar can be spaced apart from the anchoring surface to provide a collar gap. The collar can make a portion (e.g., the threaded portion optionally located within the collar gap) of the anchor posts inaccessible to the unitary nut because the collar interferes with (e.g., blocks, prevents, inhibits, or the like) the translation of the unitary nut relative to the anchor posts. Additionally, the present inventors have recognized, among other things, that another problem to be solved can include improving a loading capacity of the utility pole mounting structure. Utility poles and the utility pole mounting structure can be subject to a variety of forces (e.g., additional equipment or wires, wind, or the like).

The present subject matter can help provide a solution to this problem, such as by providing a split nut. The split nut can include a first nut portion and a second nut portion. The first nut portion can define a first receptacle and a second receptacle. The second nut portion can define a first passage and a second passage, and the first and second passages can be designed and manufactured to be respectively positioned or located to align with the first and second receptacles. In an example, a center to center distance between the first and second passages can correspond to (e.g., equal, or be substantially the same as) a center to center distance of the first and second receptacles. In another example, a circumference of the first and second passages can correspond to a circumference of the first and second receptacles. A first pin and a second pin can respectively extend through the first and second passages to respectively engage with the first and second receptacles, for instance to secure the first and second nut portions together to close the split nut and thereby define a nut passage.

The split nut can be engaged with the threaded portion that is inaccessible via the unitary nut, such as because of the collar. For instance, the first nut portion and the second nut portion can be engaged with the threaded portion, and the first nut portion and the second nut portion can be secured together to close the split nut to locate the split nut about the threaded portion. In this example, because the first nut portion and the second nut portion are separate, the split nut can engage with the threaded portion without interference from the collar. Accordingly, the split nut can be coupled to the utility pole mounting fixture while the collar is coupled to the one or more anchor posts. Additionally, the split nut can increase a loading capacity of the utility pole mounting structure because the split nut increases the mechanical strength of the mounting structure, for instance the mechanical strength of the coupling between the collar and the one or more anchor posts. Accordingly, when the utility pole is coupled to the mounting structure using the additional split nut, the mounting structure can withstand greater stresses and strains as a result of the loads applied to the utility pole.

Aspect 1 can include or use subject matter (such as an apparatus, a system, a device, a method, a means for performing acts, or a device readable medium including instructions that, when performed by the device, can cause the device to perform acts, or an article of manufacture), such as can include or use a utility pole mounting structure, comprising: a utility pole ground mounting fixture comprising a threaded portion inaccessible via a unitary nut after attachment of a collar; and a split nut, located about the threaded portion, the split nut including: first and second nut portions, wherein the first nut portion defines first and second receptacles, and wherein the second nut portion defines first and second passages located to align with the first and second receptacles; and first and second pins, respectively extending through the first and second passages to respectively engage with the first and second receptacles to secure the first and second nut portions together to close the split nut and thereby define a nut passage.

Aspect 2 can include or use, or can optionally be combined with the subject matter of Aspect 1, to optionally include or use in combination with a utility pole configured to be mounted thereto.

Aspect 3 can include or use, or can optionally be combined with the subject matter of one or any combination of Aspects 1 or 2 to optionally include or use wherein: the utility pole ground mounting fixture includes one or more anchor posts extending from an anchoring surface, and at least one of the anchor posts includes the threaded portion; the utility pole ground mounting fixture includes the collar spaced apart from the anchoring surface to provide a collar gap, and the one or more anchor posts extend through the collar; the unitary nut is located about the at least one of the anchor posts and is located on a first side of the collar, and the split nut is located about the at least one of the anchor posts on the threaded portion on a second side of the collar in the collar gap; and the collar is coupled to the one or more anchor posts with the unitary nut and the split nut.

Aspect 4 can include or use, or can optionally be combined with the subject matter of Aspect 3 to optionally include or use wherein the unitary nut located on the first side of the collar is a first unitary nut, and further comprising a second unitary nut located on the second side of the collar and the second unitary nut is located between the collar and the split nut, wherein the split nut is included to improve a loading capacity of the utility pole mounting structure.

Aspect 5 can include or use, or can optionally be combined with the subject matter of one or any combination of Aspects 3 or 4 to optionally include or use wherein the one or more anchor posts extend beyond the unitary nut to allow a utility pole to be mounted to the utility pole mounting structure.t

Aspect 6 can include or use, or can optionally be combined with the subject matter of one or any combination of Aspects 3 through 5 to optionally include or use in combination with a utility pole coupled to the utility pole mounting structure on the first side of the collar.

Aspect 7 can include or use subject matter (such as an apparatus, a system, a device, a method, a means for performing acts, or a device readable medium including instructions that, when performed by the device, can cause the device to perform acts, or an article of manufacture), such as can include or use a split nut, comprising: a first nut portion and a second nut portion, wherein the first nut portion defines a first receptacle and a second receptacle, and wherein the second nut portion defines a first passage and a second passage respectively located to align with the first and second receptacles; and a first pin and a second pin, the first and second pins respectively extending through the first and second passages to respectively engage with the first and second receptacles to secure the first and second nut portions together to close the split nut and thereby define a nut passage.

Aspect 8 can include or use, or can optionally be combined with the subject matter of Aspect 7, to optionally include or use wherein the first and second receptacles are coaxial to the first and second passages, respectively, and the first and second receptacles are perpendicular to the nut passage.

Aspect 9 can include or use, or can optionally be combined with the subject matter of one or any combination of Aspects 7 or 8 to optionally include or use wherein: the first nut portion includes a first face and the first and second receptacle extend between the first face and one or more back surfaces of the first nut portion; the second nut portion includes a second face and the first and second passages extend between the second face and one or more back surfaces of the second nut portion; and the first face is configured to mate with the second face.

Aspect 10 can include or use, or can optionally be combined with the subject matter of one or any combination of Aspects 7 through 9 to optionally include or use wherein the first passage and the second passage are respectively sized and shaped to receive a driving head of the first and second pins.

Aspect 11 can include or use, or can optionally be combined with the subject matter of one or any combination of Aspects 7 through 10 to optionally include or use wherein: the first receptacle includes a first threaded portion; the first pin includes a second threaded portion; and the first threaded portion corresponds with the second threaded portion and engagement of the first threaded portion with the second threaded portion thereby couples the first pin with the first receptacle.

Aspect 12 can include or use, or can optionally be combined with the subject matter of one or any combination of Aspects 7 through 11 to optionally include or use wherein the nut passage is threaded.

Aspect 13 can include or use, or can optionally be combined with the subject matter of one or any combination of Aspects 7 through 12 to optionally include or use wherein the first nut portion includes a flange recessed within the first passage or the second passage, and wherein the flange is configured to engage with the first pin or the second pin.

Aspect 14 can include or use, or can optionally be combined with the subject matter of one or any combination of Aspects 7 through 13 to optionally include or use wherein the first and second pins respectively extend through the first and second passages and respectively engage with the first and second receptacles.

Aspect 15 can include or use subject matter (such as an apparatus, a system, a device, a method, a means for performing acts, or a device readable medium including instructions that, when performed by the device, can cause the device to perform acts, or an article of manufacture), such as can include or use a method for increasing a loading capacity of a utility pole mounting structure, comprising: engaging a first nut portion of a split nut with a threaded portion that is then inaccessible via a unitary nut; engaging a second nut portion of the split nut with the threaded portion; installing a first pin within a first passage in the second nut portion and engaging a first receptacle in the first nut portion; installing a second pin within a second passage in the second nut portion and engaging the second pin with the second receptacle in the first nut portion; and using the first and second pins, securing the first nut portion and the second nut portion together to close the split nut.

Aspect 16 can include or use, or can optionally be combined with the subject matter of Aspect 15, to optionally include or use mating a first face of the first nut portion with a second face of the second nut portion.

Aspect 17 can include or use, or can optionally be combined with the subject matter of one or any combination of Aspects 15 or 16 to optionally include or use aligning the first passage of the first nut portion with the first receptacle of the second nut portion; and aligning the second passage of the first nut portion with the second receptacle of the second nut portion.

Aspect 18 can include or use, or can optionally be combined with the subject matter of one or any combination of Aspects 15 through 17 to optionally include or use driving the split nut to translate the split nut relative to the threaded portion.

Aspect 19 can include or use, or can optionally be combined with the subject matter of one Aspect 18 optionally include or use engaging the split nut with a unitary nut to provide a compressive force between the split nut and the unitary nut, wherein the compressive force between the split nut and the unitary nut increases a loading capacity of the utility pole mounting structure.

Aspect 20 can include or use, or can optionally be combined with the subject matter of one or any combination of Aspects 15 through 19 to optionally include or use positioning the first nut portion between a collar and an anchoring surface, wherein the collar is remote from the anchoring surface; and positioning the second nut portion between the collar and the anchoring surface.

Aspect 21 can include or use, or can optionally be combined with any portion or combination of any portions of any one or more of Aspects 1 through 20 to include or use, subject matter that can include means for performing any one or more of the functions of Aspects 1 through 20, or a machine-readable medium including instructions that, when performed by a machine, cause the machine to perform any one or more of the functions of Aspects 1 through 20.

Each of these non-limiting aspects can stand on its own, or can be combined in various permutations or combinations with one or more of the other aspects.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic view of a utility pole mounting structure and a utility pole.

FIG. 2 is a perspective view of one example of the utility pole mounting structure of FIG. 1.

FIG. 3 is a top view of a split nut.

FIG. 4 is a top view of a pin.

FIG. 5 is a detailed schematic view of the utility pole mounting structure of FIG. 1.

FIG. 6 shows one example of a method for increasing a loading capacity of a utility pole mounting structure.

FIG. 7 shows a top view of an anchor nut for a utility pole in accordance with some example embodiments.

FIG. 8 shows a side view of the anchor nut from FIG. 7 in accordance with some example embodiments.

FIG. 9 shows a cross section diagram of a thread from an anchor nut in accordance with some example embodiments.

FIG. 10 shows a utility pole anchoring system in accordance with some example embodiments.

FIG. 11 shows a flow diagram of a method of anchoring a utility pole in accordance with some example embodiments.

### DETAILED DESCRIPTION

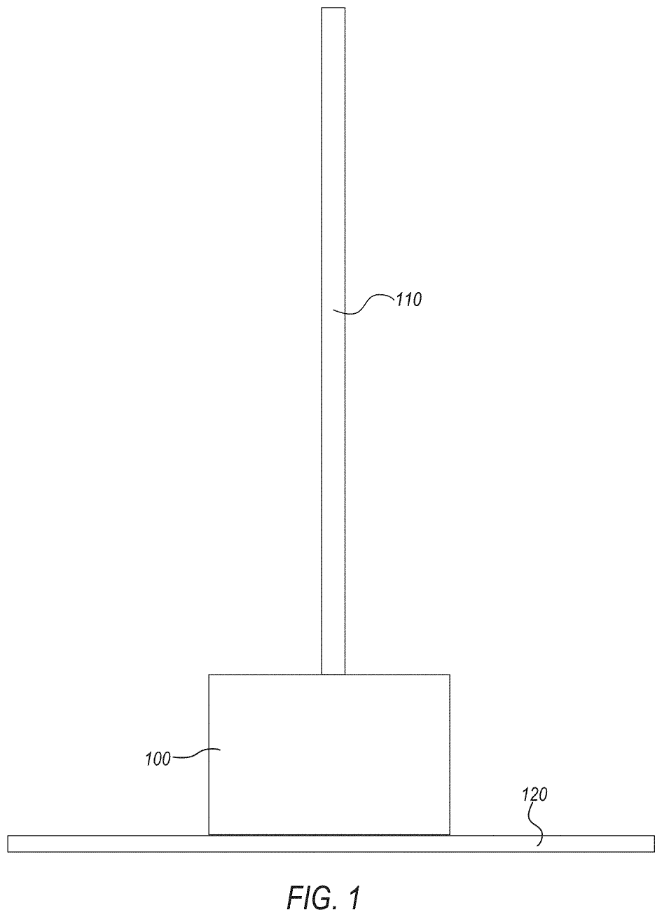

FIG. 1 is a schematic view of a utility pole mounting structure 100 and a monopole or other utility pole 110. The mounting structure 110 can be coupled to an anchoring surface 120 (e.g., a ground surface, a concrete footing, or the like). In one example, a portion of the mounting structure 100 is encased in concrete and then buried underground (e.g., with a fill material, for instance dirt, gravel, or the like). The utility pole 110 is configured to attach to the mounting structure 100, and the mounting structure 100 provides structural support for the utility pole 110.

The utility pole 110 can support equipment (e.g., power wires, telecommunication equipment or wires, or the like). In an example, a series of utility poles 110 are arranged alongside a roadway and power transmission lines are strung along the series of utility poles. In another example, cellular device infrastructure (e.g., antennas, data processing equipment, or the like) are coupled to the utility pole 110. The utility pole 110 extends a distance from the mounting structure 100 to elevate the equipment so that the equipment is isolated from the ground surface, for example to allow vehicles or people to travel beneath the equipment without coming into contact with the equipment.

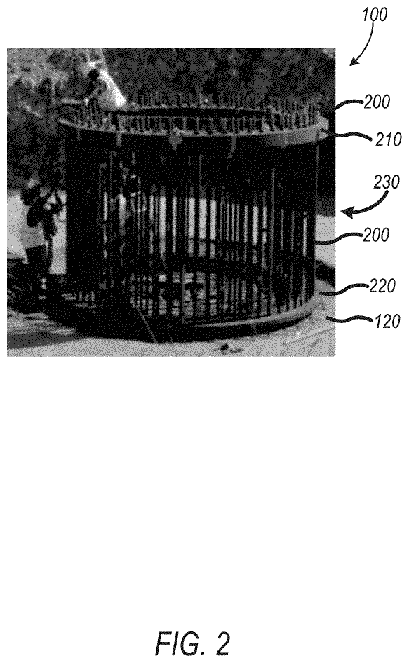

FIG. 2 is a photograph providing a perspective view of one example of the utility pole mounting structure 100 of FIG. 1. The utility pole mounting structure 100 can include one or more anchor posts 200 and a collar 210. The one or more anchor posts 200 can be coupled with the anchoring surface 120 (e.g., encased in concrete). In one example, the anchor posts 200 are assembled into the mounting structure 100 as straight rods, without any threading. After assembly into the mounting structure 100, exposed upward ends of the anchor posts 200 are optionally threaded to later accept anchor nuts that fasten the utility pole (shown in FIG. 1) to the mounting structure 100.

As described in greater detail herein, the anchor posts 200 can extend through the collar 210, and accordingly, the collar 210 can enhance the structural rigidity to the utility pole mounting structure 100. For example, the collar 210 can interconnect the one or more anchor posts 200 to enhance the loading capacity of the utility pole mounting structure 100 such that the mounting structure 100 can support the utility pole 110 (shown in FIG. 1). Additionally, the collar 210 can be space apart (e.g., elevated, raised, or the like) from the anchoring surface 120 to provide a collar gap 230. Further, the mounting structure 100 can include a base plate 220. The base plate 220 can be positioned adjacent to the anchoring surface 120 and enhance the structural rigidity of the mounting structure 110.

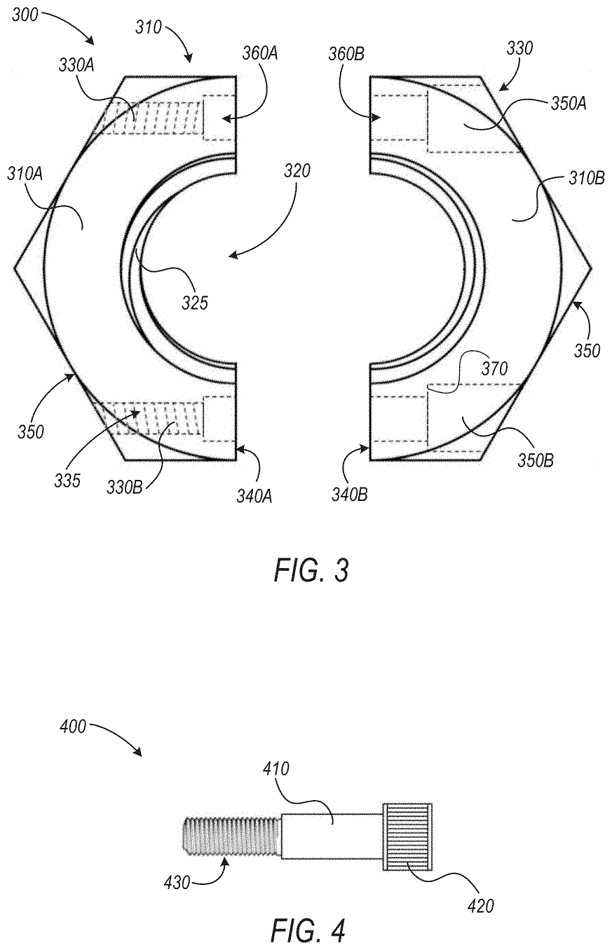

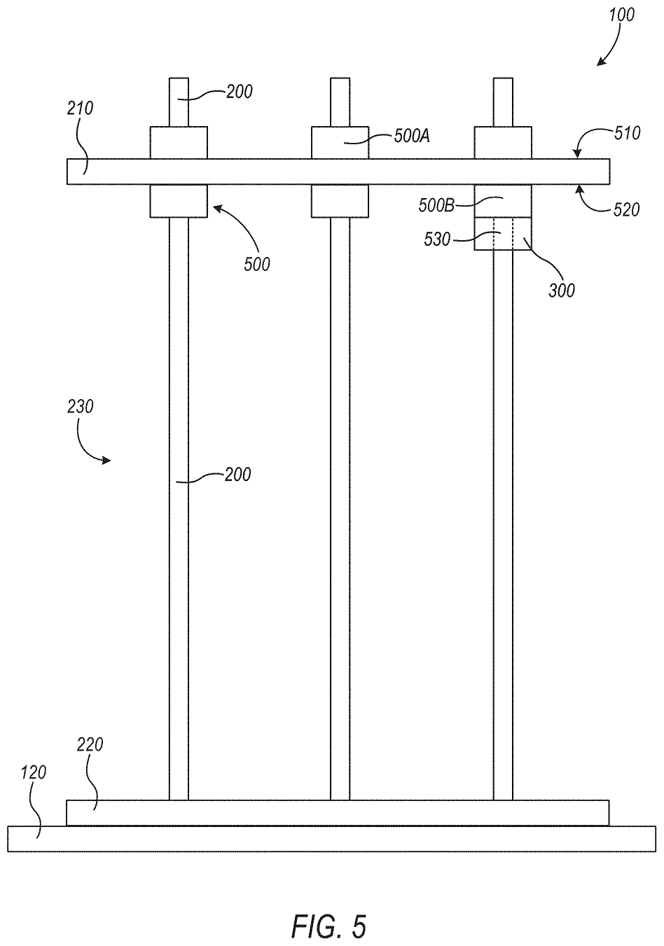

FIG. 3 is a top view of a split nut 300. As described in greater detail herein, the split nut 300 can be coupled to the one or more anchor posts 200 (shown in FIGS. 2 and 5). The split nut 300 can include nut portions 310, for instance a first portion 310A and a second portion 310B. The first portion 310A and the second portion 310B can be secured together to close the split nut 300, and the closing of the split nut 300 can define a nut passage 320. Nut threads 325 can be located in the nut passage 320 (e.g., the nut threads 325 can be cut into the nut portions 310), and the nut threads 325 can correspond to threads defined by the anchor posts 200.

The first nut portion 310A can define a first receptacle 330A and can define a second receptacle 330B. The first receptacle 330A and the second receptacle 330B can respectively extend between a first face 340A of the first nut portion 310A and one or more back surfaces 350 of the split nut 300. In some examples, and as shown in FIG. 3, the first receptacle 330A and the second receptacle 330B are perpendicular to the nut passage 320. The first receptacle 330A and the second receptacle 330B can include receptacle threads 335 to help facilitate the securing together of the first nut portion 310A and the second nut portion 310B.

The second nut portion 310B can define a first passage 350A and a second passage 350B. The first passage 350A and the second passage 350B can respectively extend between a second face 340B of the second nut portion 310B and the one or more back surfaces 350 of the split nut 300. The first passage 350A can be located in the second nut portion 310B to align with the first receptacle 330A in the first nut portion 310A. The second passage 350B can be located in the second nut portion 310B to align with the second receptacle 330B in the first nut portion 310A.

In an example, the first face 340A of the first nut portion 310A can mate with the second face 340B of the second nut portion 310B. The first receptacle 330A can define a first through hole 360A that interfaces with the first face 340A. The first passage 350A can define a second through hole 360B that interfaces with the second face 340B of the second nut portion 310B. The first through hole 360A of the first receptacle 330A can be aligned with the second through hole 360B of the first passage 350A (e.g., when the first face 340A is mated with the second face 340B) to allow a bolt, screw, or other pin (e.g., the pin 400 shown in FIG. 4) to extend through the first passage 350A and engage with the first receptacle 330A. In another example, and as shown in FIG. 3, the center to center distance between the first and second receptacles 330A, 330B can correspond to the center to center distance between the first and second passages 350A, 350B. In yet another example, the dimension (e.g., circumference) of the first through hole 360A can correspond to the dimension of the second through hole 360B.

Referring again to FIG. 3, the first passage 350A and the second passage 350B can respectively include a flange 370. The flange 370 can be recessed within the first passage 350A or the second passage 350B. In an example, the first passage can include a first portion having a first diameter, and a second portion having a second diameter, and the second diameter can be less than the first diameter. The flange 370 can be located at the transition between the first diameter to the second diameter. As described in greater detail herein, the flange 370 can engage with a pin (e.g., the pin 400 shown in FIG. 4), and the engagement of the flange 370 with the pin can help facilitate the securing of the first nut portion 310A together with the second nut portion 310B.

FIG. 4 is a top view of a pin 400. In one example, the pin 400 can be a threaded fastener (e.g., a bolt or a screw). The pin 400 can include a shank 410, a driving head 420, and pin threads 430 optionally defined in the shank 410. The pin 400 can be received by the split nut 300 and the pin 400 can engage with the split nut 300 to help secure the first nut portion 310A together with the second nut portion 310B. For instance, the pin 400 can be positioned in the first passage 350A (or the second passage 350B, shown in FIG. 3) and extend through the first passage 350A (e.g., through the second through hole 360B). In this example, because the first passage 350A is aligned with the first receptacle 330A, the pin 400 can engage with the first receptacle 330A.

The driving head 420 can include a driving feature (e.g., a slot, a Phillips head slot, a hex head, a hex key receptacle, a star-shaped receptacle, or the like) that allows the pin 400 to be driven (e.g., with a hand tool, power tool, pneumatic tool, or the like). In some examples, the driving head 420 can be driven (e.g., turned, twisted, spun, or the like) and the pin threads 430 of the pin 400 can engage with corresponding receptacle threads 335 of the first receptacle 330A. The pin 400, for example the driving head 420, can engage with the flange 370 and provide a coupling force between the nut portions 310. Accordingly, the pin 400 can help secure the first nut portion 310A together with the second nut portion 310B.

Referring again to FIG. 3, the first passage 350A or the second passage 350B can be sized and shaped to receive the driving head 420 of the pin 400 (shown in FIG. 4). In one example, the first diameter of the first passage 350A can be greater than a diameter of the driving head 420. In another example, the first passage 310 can be countersunk to allow the driving head 420 to be positioned within the first passage 350A.

FIG. 5 is a detailed schematic view of the utility pole mounting structure 100 of FIG. 1. As described herein, the one or more anchor posts 200 can extend through the collar 210 and the base plate 220. A unitary nut 500 (e.g., a nut that is a single or continuous piece) can be located about the anchor posts 200 and the unitary nut 500 can help secure the collar 210 to the anchor posts 200. For instance, a first unitary nut 500A can be located on a first side 510 of the collar 210, and a second unitary nut 500B can be located on a second side 520 of the collar 210. The unitary nuts 500A, 500B can help support the collar 210, and thereby provide the collar gap 230 between the collar 210 and the anchoring surface 230.

As described herein, the utility pole 110 (shown in FIG. 1) can be attached to the utility pole mounting structure 100. In some examples, the utility pole 110 can have additional equipment coupled to the utility pole 100 or, the utility pole 110 can be interchanged with a larger, taller, or heavier utility pole 110 that can support additional equipment. In this example, because the collar 110 is coupled to the anchor posts 200 with the unitary nuts 500, portions of the anchor posts 200 located in the collar gap 230 are inaccessible to add additional unitary nuts 500 because the collar 210 interferes with the translation of the unitary nut 500 relative to the anchor posts 200 (e.g., from the first side 510 to the second side 520 of the collar 210). For instance, and as shown in FIG. 5, the collar 210 is continuous between the one or more anchor posts 200 and prevents locating the unitary nut 500 in the collar gap 230.

The split nut 300 can be coupled with the portion of the anchor posts 200 in the collar gap 230, for example, immediately below an existing unitary nut holding up the collar 210. Accordingly, the split nut 300 can increase the loading capacity of the utility pole mounting structure 100 to support the additional equipment or the larger utility pole 110. For instance, additional telecommunications transceivers or electrical transmission lines can be coupled to the utility pole 110, thereby increasing the load applied to the mounting structure 100. In another example, the split nut 300 facilitates attaching a larger utility pole 110 to the utility pole mounting structure 100, and the larger utility pole 110 can support additional equipment.

In an example, the anchor posts 200 can each include a threaded portion 530 respectively located in the collar gap 230. In this example, because the first nut portion 310A and the second nut port 310B can be secured together, the split nut 300 can be located about the threaded portion 530 in the collar gap 230 without removing the collar 210 from the one or more anchor posts 200. For instance, the split nut 300 can be located about the threaded portion 530 and engaged with the unitary nut 500B to increase the loading capacity of the anchor post 200 (e.g., a load applied to the first side 510 of the collar 210). Accordingly, the split nut 300 facilitates adding additional equipment to the utility pole 110 without requiring removal of the collar 210 from the mounting structure 100. As a result, the split nut 300 can reduce the costs and rework associated with increasing the loading capacity of the utility pole mounting structure 100.

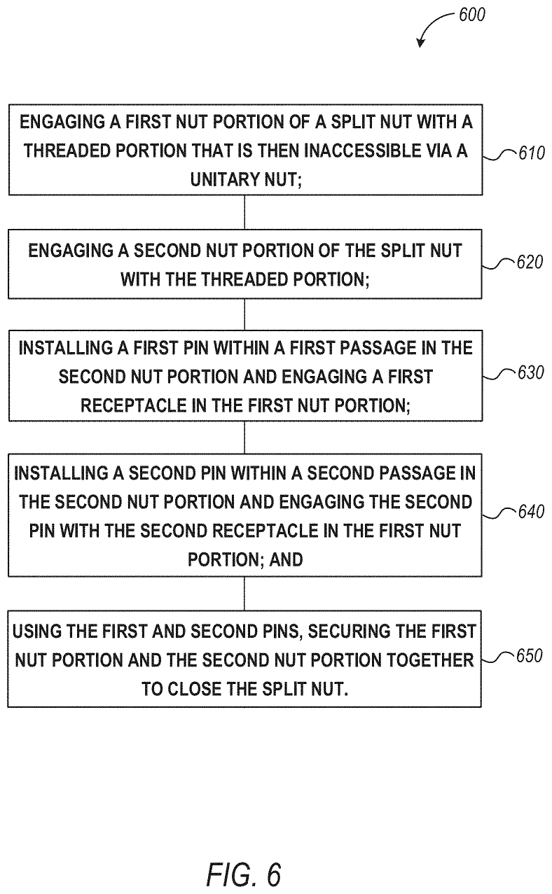

FIG. 6 shows one example of a method 600 for increasing the loading capacity of a utility pole mounting structure 100, including one or more of the split nut 300 described herein. In describing the method 600, reference is made to one or more components, features, functions and operations previously described herein. Where convenient, reference is made to the components, features, operations and the like with reference numerals. The reference numerals provided are exemplary and are not exclusive. For instance, components, features, functions, operations and the like described in the method 600 include, but are not limited to, the corresponding numbered elements provided herein and other corresponding elements described herein (both numbered and unnumbered) as well as their equivalents.

At 610, a first nut portion 310A of a split nut 300 can be engaged with a threaded portion 530 that is then inaccessible via a unitary nut 500. At 620, a second nut portion 310B of the split nut 300 can be engaged with the threaded portion 510. The method 600 can include at 630, installing a first pin 400 within a first passage 350A in the second nut portion 310B. The first pin 400 can be engaged with a first receptacle 530A in the first nut portion 310A. At 640, a second pin 400 can be installed within a second passage 350B in the second nut portion 310B. The second pin 400 can be engaged with the second receptacle 330B in the first nut portion 310A. At 650, the first and second pins 400 can be used to secure the first nut portion 310A and the second nut portion 310B together to close the split nut 300.

Several options for the method 600 follow. In an example a first face 340A of the first nut portion 310A can be mated with a second face 340B of the second nut portion 310B. In another example, the first passage 350A can be aligned with the first receptacle 330A, and the second passage 350B can be aligned with the second receptacle 330B. In yet another example, the split nut 300 can be driven to translate the split nut 300 relative to the threaded portion 530. For instance, the split nut 300 can be translated to engage with the unitary nut 500 to provide a compressive force between the split 300 nut and the unitary nut 500. The compressive force between the split nut 300 and the unitary nut 500 can increase a loading capacity of the utility pole mounting structure 100. In still yet another example, the first nut portion 310A can be positioned between a collar 210 and an anchoring surface 120. The collar 210 can be spaced apart from the anchoring surface 120. The second nut portion 310B can be positioned between the collar 210 and the anchoring surface 120.

Referring again to FIG. 2, and as described herein, the anchor posts 200 are optionally threaded to later accept anchor nuts that fasten the utility pole 110 (shown in FIG. 1) to the utility pole mounting structure 100. In one example, threads are cut onto the exposed upward ends of the anchor posts 200, using a tool such as a thread cutting die. In one example, the threads are rolled, or otherwise pressed into the exposed upward ends of the anchor posts 200, using a tool such as a thread roller. Thread rolling includes the added advantage of hardening the threads through deformation as the threads are created, forming a robust and stronger thread connection.

In the process of thread rolling, a pressure is applied to an outer diameter of the exposed upward ends of the anchor posts 200, and the thread rolling die is rotated to press in the threads. If too high a pressure is used to roll the threads, a non-conforming anchor post diameter may result. The material of the exposed upward ends of the anchor posts 200 may be pressed so hard, that too small a diameter is left after the rolling process. This creates a challenging situation, where standard thread sizes in mating anchor nuts will not securely hold against the anchor posts 200. In addition, due to variations in applied rolling pressure between individual thread rolling operations, there may be corresponding variations in thread diameter between individual anchor posts 200 in the mounting structure 100.

It can be cost prohibitive to correct the non-conforming anchor posts 200. Correction may entail breaking up of anchoring concrete, and sawing out non-conforming welded anchor posts 200 from the mounting structure 100. The present inventors have recognized that although the exposed upward ends of the anchor posts 200 may be non-conforming in diameter, they are still well within the required tensile strength to securely hold the utility pole 100 (shown in FIG. 1), if a correctly fitting anchor nut were provided.

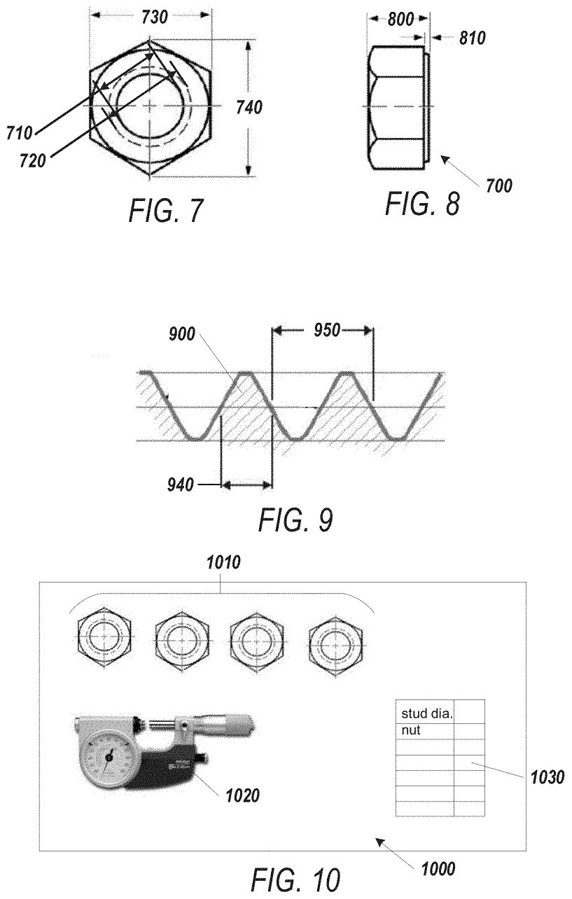

FIG. 7 shows a top view of an anchor nut 700 from a utility pole anchoring system according to one example of the invention. The anchor nut 700 has a minor thread diameter 710, and a major thread diameter 720. The anchor nut 700 also has a pitch diameter (not shown in FIG. 8—defined as 226, FIG. 9) with dimensions between the minor thread diameter 710 and the major thread diameter 720. The pitch diameter is described in more detail below.

Independent of the thread diameters, the anchor nut 700 is shown with tooling dimensions 730, 740. In one example, dimensions 730 and 740 are consistent with a standard size 2-inch anchor nut. The standard dimension of 2 inches refers to the thickness 214 shown in FIG. 8. In one example, the standard tooling dimensions 730, 740 for a 2-inch anchor nut include a dimension of 3⅛ inches for dimension 730, and 3⅝ inches for dimension 740.

FIG. 8 further illustrates an anchor nut thickness 800, and a relief flange thickness 810. In the example of a standard 2-inch anchor nut, the anchor nut thickness 800 is 2 inches and the relief flange thickness 810 is approximately 0.16 inches. Although the relief flange thickness 810 is shown in the example of FIG. 8, the invention is not so limited. Other examples of anchor nuts 700 may not include a relief flange.

FIG. 9 shows an example cross section diagram of a thread 900 and associated thread diameters (910, 920, 930) from an anchor nut, such as anchor nut 700 from FIGS. 7 and 8. The pitch diameter 930 (often called the effective diameter) of a parallel thread is defined as the diameter of an imaginary co-axial cylinder which intersects the surface of the thread 900 in such a manner that the intercept on a generator of the cylinder, between the points where it meets the opposite flanks of a thread groove, is equal to half 940 the nominal pitch 950 of the thread 900.

The major diameter 910 of the thread 900 is the diameter of the imaginary co-axial cylinder that just touches the crest of an external thread or the root of an internal thread. The minor diameter 920 of the thread 900 is the diameter of an imaginary cylinder that just touches the roots of an external thread or the crests of an internal thread.

FIG. 10 shows a utility pole anchoring system 1000 according to one example. A set of anchor nuts 1010 is shown. The set of anchor nuts 1010 includes nuts having at least one non-standard thread dimension. Optionally, the set of anchor nuts 1010 can include the split nut 300 (shown in FIG. 3), and the nut threads 325 can include the non-standard thread dimension. The example utility pole anchoring system 1000 further includes a measuring device 1020 to determine a diameter of an anchor post (e.g., the anchor post 200 shown in FIG. 2) after threads have been formed on an exposed end. In the example shown, a caliper 1020 is shown to measure an outer diameter of an anchor post thread. Other measuring devices such as an array of gauge holes, or gauge slots may be used.

The example utility pole anchoring system 1000 further includes a chart 1030 to associate an anchor nut having a listed thread dimension with an anchor post having a corresponding thread dimension. In one example, one or more of the listed thread dimensions are non-standard. The term “thread dimension” may refer to any of the above defined thread dimensions, for example minor diameter, major diameter, or pitch diameter. However, when comparing an anchor nut dimension to an anchor post dimension, the same type of dimension should be used to ensure consistent matching.

Although a chart 1030 is shown, the invention is not so limited. For example, a database, spreadsheet, or other system of noting a corresponding relationship may be used without departing from the scope of the invention.

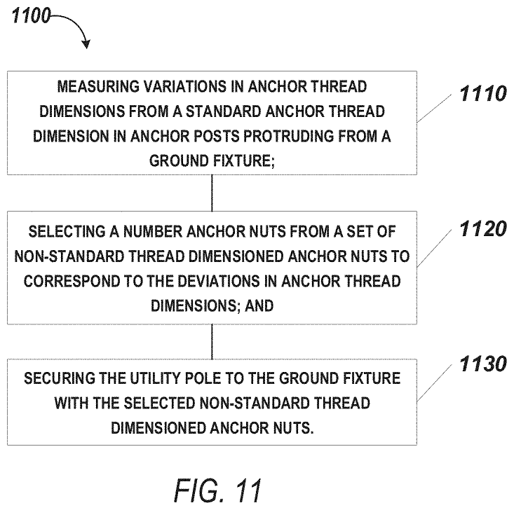

FIG. 11 illustrates an example method of use for the utility pole anchoring system 1000 of FIG. 10. Operation 1110 shows a field worker or other person measuring deviations in anchor thread dimensions from a standard anchor thread dimension in anchor posts protruding from a ground fixture. In one example, the caliper 1020 as shown in FIG. 10 may be used. Other types of measuring devices may be used.

In operation 1120, a number of anchor nuts from a set of non-standard thread dimensioned anchor nuts are selected to correspond to deviations in anchor thread dimensions from a standard, as measured on the anchor posts. In one example, the set of anchor nuts 1010 may include some standard thread dimensioned anchor nuts, however, one or more of the set of anchor nuts 1010 also includes a non-standard thread dimension. In one example, the non-standard thread dimension is smaller than the standard thread dimension. In one example, the set of anchor nuts 1010 includes two or more different non-standard thread dimensions, both of which are smaller than the standard thread dimension. In operation 1130, the utility pole is secured to the ground fixture with the selected non-standard thread dimensioned anchor nuts.

When properly chosen from the set of anchor nuts 1010, a non-standard thread dimensioned anchor nut will engage properly with a corresponding non-standard anchor post where threads are rolled or cut slightly smaller than a standard thread dimension. By having a plurality of non-standard thread dimensioned anchor nuts to choose from, several variations in threaded anchor posts can be accommodated without removal and replacement. By using utility pole anchoring systems 1000, as described in the present disclosure, expensive rework of non-conforming ground fixtures is avoided.

In one example, two non-standard anchor nuts are provided in the set of anchor nuts 1010, in addition to one or more standard threaded anchor nuts. The chart below shows an example of two non-standard threadings for non-standard anchor nuts M1 and M2. Although specific dimensions are shown as an example, the invention is not so limited. Other sets of anchor nuts may be used to accommodate deviations in dimension associated with different anchor posts.

One common size anchor nut for use with utility pole anchoring is a standard 2-inch nut. In the chart above, the M1 and M2 dimensions are chosen to accommodate variations from a standard 2-inch nut where anchor post threads are rolled slightly smaller than a conforming thread. In one example although the standard thread, the M1 thread, and the M2 thread are all different, the tooling dimensions are all the same. In this way, a single standard wrench/socket may be used to secure all of the anchor nuts.

Although a 2-inch standard hexagonal tooling surface is used as an example, other standard anchor nut and tooling surface dimensions are also within the scope of the invention. Although a hexagonal tooling surface is used as an example, other tooling surfaces, such as square, splined, etc. are also within the scope of the invention.

In one example all non-standard thread dimensions fall between a standard thread size, and a next smaller standard size. In selected examples, it can be important that the anchor post is only slightly smaller than the desired standard dimension. In order to provide adequate structural strength, it may not be possible to merely size down the anchor post to the next smaller standard size. The set of anchor nuts 1010 described above accomplishes the goal of maintaining structural strength, while also accommodating slightly smaller non-standard thread dimensions.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A utility pole mounting structure, comprising:
a utility pole ground mounting fixture comprising a threaded portion inaccessible via a unitary nut after attachment of a collar; and
a split nut, located about the threaded portion, the split nut including:
first and second nut portions, wherein the first nut portion defines first and second receptacles, and wherein the second nut portion defines first and second passages located to align with the first and second receptacles; and
first and second pins, respectively extending through the first and second passages to respectively engage with the first and second receptacles to secure the first and second nut portions together to close the split nut and thereby define a nut passage.

2. The utility pole mounting structure of claim 1, in combination with a utility pole configured to be mounted thereto.

3. The utility pole mounting structure of claim 1, wherein:
the utility pole ground mounting fixture includes one or more anchor posts extending from an anchoring surface, and at least one of the anchor posts includes the threaded portion;
the utility pole ground mounting fixture includes the collar spaced apart from the anchoring surface to provide a collar gap, and the one or more anchor posts extend through the collar;
the unitary nut is located about the at least one of the anchor posts and is located on a first side of the collar, and the split nut is located about the at least one of the anchor posts on the threaded portion on a second side of the collar in the collar gap; and
the collar is coupled to the one or more anchor posts with the unitary nut and the split nut.

4. The utility pole mounting structure of claim 3, wherein the unitary nut located on the first side of the collar is a first unitary nut, and further comprising a second unitary nut located on the second side of the collar and the second unitary nut is located between the collar and the split nut, wherein the split nut is included to improve a loading capacity of the utility pole mounting structure.

5. The utility pole mounting structure of claim 3, wherein the one or more anchor posts extend beyond the unitary nut to allow a utility pole to be mounted to the utility pole mounting structure.

6. The utility pole mounting structure of claim 3, in combination with a utility pole coupled to the utility pole mounting structure on the first side of the collar.

7. A split nut, comprising:
a first nut portion and a second nut portion, wherein the first nut portion defines a first receptacle and a second receptacle, and wherein the second nut portion defines a first passage and a second passage respectively located to align with the first and second receptacles; and
a first pin and a second pin, the first and second pins respectively extending through the first and second passages to respectively engage with the first and second receptacles to secure the first and second nut portions together to close the split nut and thereby define a nut passage

8. The split nut of claim 7, wherein the first and second receptacles are coaxial to the first and second passages, respectively, and the first and second receptacles are perpendicular to the nut passage.

9. The split nut of claim 7, wherein:
the first nut portion includes a first face and the first and second receptacle extend between the first face and one or more back surfaces of the first nut portion;
the second nut portion includes a second face and the first and second passages extend between the second face and one or more back surfaces of the second nut portion; and
the first face is configured to mate with the second face.

10. The split nut of claim 7, wherein the first passage and the second passage are respectively sized and shaped to receive a driving head of the first and second pins.

11. The split nut of claim 7, wherein:
the first receptacle includes a first threaded portion;
the first pin includes a second threaded portion; and
the first threaded portion corresponds with the second threaded portion and engagement of the first threaded portion with the second threaded portion thereby couples the first pin with the first receptacle.

12. The split nut of claim 7, wherein the nut passage is threaded.

13. The split nut of claim 7, wherein the first nut portion includes a flange recessed within the first passage or the second passage, and wherein the flange is configured to engage with the first pin or the second pin.

14. The split nut of claim 7, wherein the first and second pins respectively extend through the first and second passages and respectively engage with the first and second receptacles.

15. A method for increasing a loading capacity of a utility pole mounting structure, comprising:
engaging a first nut portion of a split nut with a threaded portion that is then inaccessible via a unitary nut;
engaging a second nut portion of the split nut with the threaded portion;
installing a first pin within a first passage in the second nut portion and engaging a first receptacle in the first nut portion;
installing a second pin within a second passage in the second nut portion and engaging the second pin with the second receptacle in the first nut portion; and
using the first and second pins, securing the first nut portion and the second nut portion together to close the split nut.

16. The method of claim 15, further comprising mating a first face of the first nut portion with a second face of the second nut portion.

17. The method of claim 15, further comprising:
aligning the first passage of the first nut portion with the first receptacle of the second nut portion; and
aligning the second passage of the first nut portion with the second receptacle of the second nut portion.

18. The method of claim 15, further comprising driving the split nut to translate the split nut relative to the threaded portion.

19. The method of claim 18, further comprising engaging the split nut with a unitary nut to provide a compressive force between the split nut and the unitary nut, wherein the compressive force between the split nut and the unitary nut increases a loading capacity of the utility pole mounting structure.

20. The method of claim 15, further comprising:
positioning the first nut portion between a collar and an anchoring surface, wherein the collar is remote from the anchoring surface; and
positioning the second nut portion between the collar and the anchoring surface.
